(19) United States
(12) Patent Application Publication
(10) Pub. No.: US 2015/0200576 A1
(43) Pub. Date: Jul. 16, 2015

(54) BRUSHLESS MOTOR

(71) Applicant: lchinomiya Denki Co., Ltd., Hyogo (JP)

(72) Inventor: Yoshikazu KINASHI, Hyogo (JP)

(21) Appl. No.: 14/510,563

(22) Filed: Oct. 9, 2014

(30) Foreign Application Priority Data
Oct. 18, 2013 (JP) 2013-216978

(51) Int. Cl. H02K 3/28; H02K 11/00; H02K 1/27; H02K 3/34

(52) U.S. Cl. CPC H02K 3/28; H02K 3/345; H02K 11/0021; H02K 1/276

(57) ABSTRACT

A brushless motor has a stator core in which at least nine teeth disposed with a gap on the same circumference are projected from a core yoke, an insulator fitted onto each of the teeth, a coil wound around each of the teeth through the insulator, a rotor which has a multipolar magnet disposed facing the teeth with a gap and which can freely rotate around the axis line passing through the center of the same circumference, hall elements disposed in gaps of the adjacent teeth, and a printed circuit board which is supported by the insulator at one end side in the axis line direction of the stator core and on which each hall element is mounted. The printed circuit board has a first circuit pattern which connects each coil and a second circuit pattern which is connected to the hall elements.

### BACKGROUND OF THE INVENTION

The present invention relates to a brushless motor capable of detecting the position of a rotor with a magnetic sensor.

Heretofore, a brushless motor having a magnetic sensor, such as a hall element which detects the rotation angle of a rotor rotating with respect to a stator forming a magnetic field is known (for example, Citation List 1 to 3).

In a brushless motor disclosed in Citation List 1, a hall element is disposed facing a permanent magnet for phase detection provided in a back lid of a motor case, separately from a permanent magnet provided in a rotor.

In brushless motor disclosed in Citation List 2 and 3, a hall element is mounted on a surface opposite to the surface where a permanent magnet is provided in a circuit board. Herein, the position where the hall element is mounted is a position facing the permanent magnet provided in the rotor with respect to the axial direction.

The brushless motor disclosed in Citation List 1 is required to have a permanent magnet for phase detection in addition to the permanent magnet provided in the rotor. Therefore, the cost of the brushless motor increases.

In the brushless motors disclosed in Citation List 2 and 3, the hail element is disposed facing the permanent magnet with respect to the axial direction. Therefore, the size of the brushless motor increases in the axial direction.

The present invention has been made in view of the circumstances described above. It is an object of the present invention to provide, a brushless motor in which an increase in cost and size can be suppressed while disposing a magnetic sensor.

### CITATION LIST

Japanese Unexamined Patent Application Publication No. 6-276719

Japanese Unexamined Patent Application Publication No. 2012-120396

Japanese Unexamined Patent Application Publication No. 2010-93905

### SUMMARY OF THE INVENTION

A brushless motor according to the present invention has a stator core in which at least three teeth disposed with a gap on the same circumference are projected from a core yoke, an insulator fitted onto each of the teeth, a coil wound around each of the teeth through the insulator, a rotor which has a multipolar magnet disposed facing the teeth with a gap and which can freely rotate around the axis line passing through the center of the same circumference, magnetic sensors disposed in each of at least three paps among the gaps of the adjacent teeth, and a printed circuit board which is supported by the insulator at one-end side in the axis line direction of the stator core and on which each magnetic sensor is mounted. The printed circuit board has a first circuit pattern which connects each coil and a second circuit pattern which is connected to the magnetic sensors.

According to the brushless motor of the present invention, even when a magnetic sensor is disposed, an increase in cost and size can be suppressed.

### BRIEF DESCRIPTION OF THE DRAWINGS

FIG. 1 is a schematic view illustrating the configuration of a brushless motor 30 and a controller 37 according to an embodiment of the present invention.

FIG. 2 is a perspective view of the brushless motor 30.

FIG. 3 is a plan view illustrating the internal configuration of the brushless motor 30.

FIG. 4 is a cross sectional view illustrating the internal configuration of the brushless motor 30.

FIG. 5 is a wire connection wiring diagram of coils 39.

FIG. 6(A) is a plan view schematically illustrating the internal structure of the brushless motor 30 which is not provided with a communication region 63.

FIG. 6(B) is a plan view schematically illustrating the internal structure of the brushless motor 30 which is provided with a communication region 63.

FIG. 7 is a plan view of a printed circuit board 35.

FIG. 8(A) is a view illustrating the relationship between the electric angle and the phase voltage when the brushless motor 30 illustrated in FIG. 6(A) is operated.

FIG. 8(B) is a view illustrating the relationship between the electric angle and the phase voltage when the brushless motor 30 illustrated in FIG. 6(B) is operated.

FIG. 9(A) is a plan view of a rotor 31 in the state where magnets 40 are not inserted.

FIG. 9(B) is a perspective view of the rotor 31 of FIG. 9(A).

FIG. 9(C) is a plan view of the rotor 31 in the state where the magnets 40 are inserted.

FIG. 9(D) is a perspective view of the rotor 31 of FIG. 9(C).

FIGS. 10(A) and 10(C) are perspective views of the rotor 31 according to a modification and illustrate the state where the magnets 40 are not inserted.

FIGS. 10(B) and 10(D) are perspective views of the rotor 31 according to a modification and illustrate the state where the magnets 40 are inserted.

FIG. 11(A) is a plan view schematically illustrating the internal structure of a 6-pole 9-slot brushless motor 30 according to a modification.

FIG. 11(B) is a plan view schematically illustrating the internal structure of a 10-pole 12-slot brushless motor according to a modification.

### DESCRIPTION OF THE PREFERRED EMBODIMENTS

Hereinafter, the present invention is described in detail based on a desirable embodiment referring to the drawings as appropriate. This embodiment is merely an example of the present; invention and may he suitably modified insofar as the gist of the present invention is not altered.

### [Schematic Structure of Brushless Motor 30]

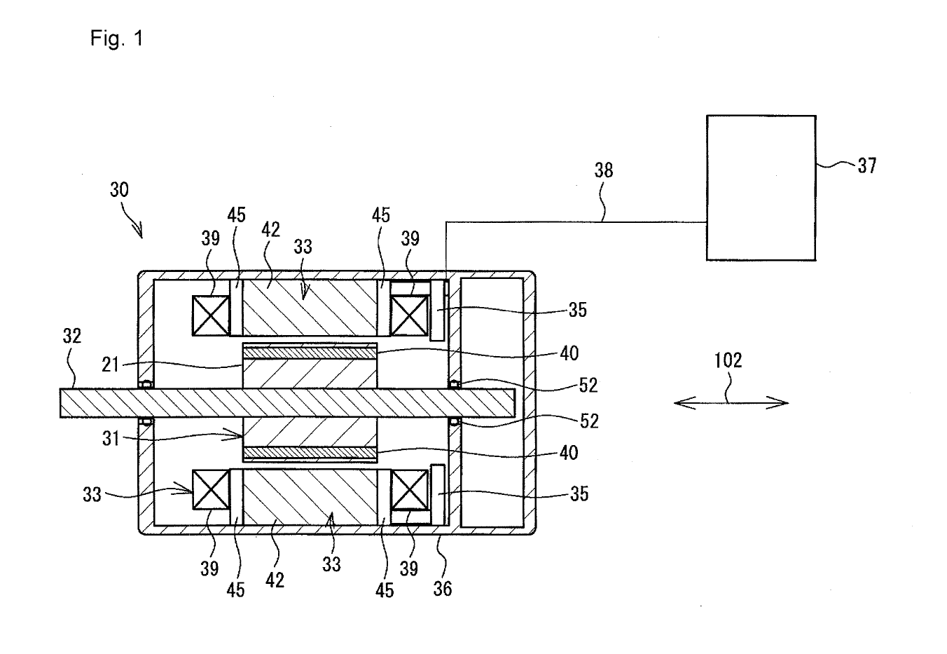

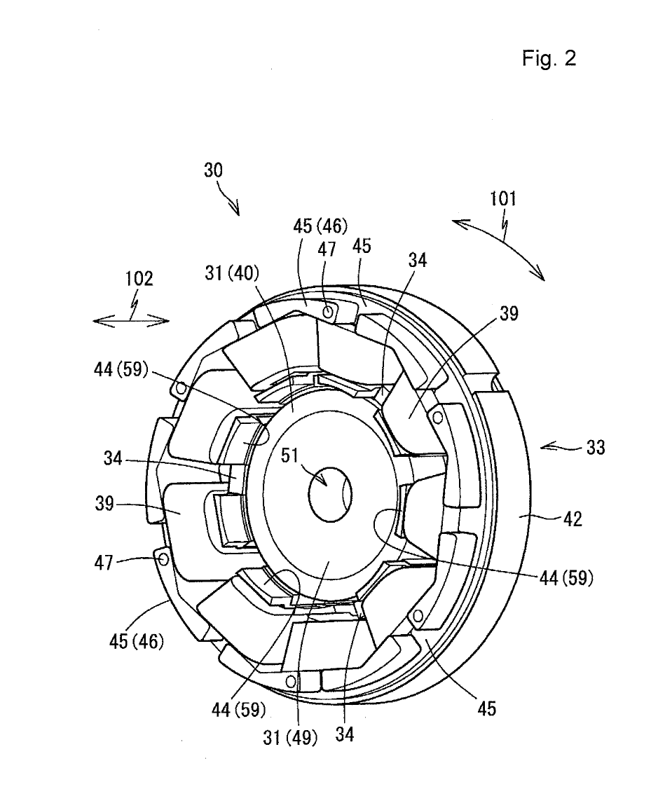

The brushless motor 30 illustrated in FIG. 1 has a rotor 31, a shaft 32, a stator 33, a hall element 34 (refer to FIG. 2 to FIG. 4), a printed circuit board 35, a housing 36, and the like. The housing 36 accommodates the rotor 31, the shaft 32, the stator 33, and the hall element 34 therein. The brushless motor 30 is electrically connected to a controller 37 which supplies electric power through a harness 3. The controller 37 is electrically connected to coils 39 of the stator 33. Then a voltage supplied from the controller 37 is applied to the coils 39. The controller 37 applies voltages of three phases of a U phase, a V phase, and a W phase. Thus, the rotor 31 rotates,

[Stator 33]

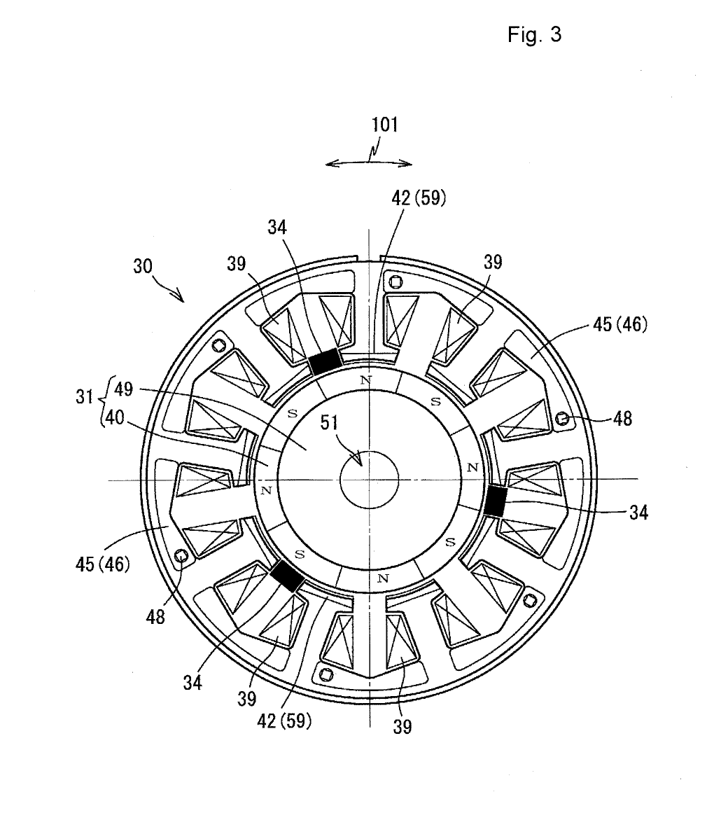

As illustrated in FIGS. 1 to 4, the stator 33 has a stator core 42, an insulator 45, and a coil 39. The stator 33 is one in which the coils 39 are wound around the stator core 42 having an approximately cylindrical shape. The stator core 42 is one in which a plurality of steel plates having a shape as viewed in plan illustrated in FIG. 3 are laminated in an axial direction 102 and then combined to each other by crimping.

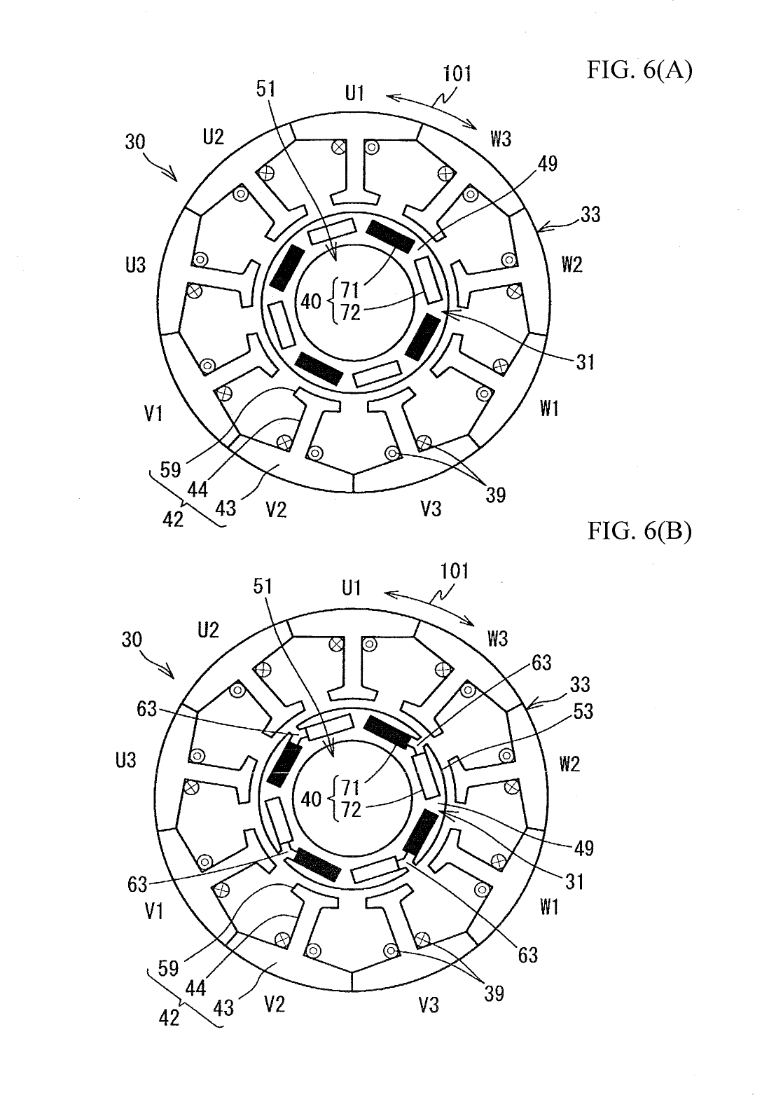

As illustrated in FIG. 6(B), the stator core 42 has a core yoke 43 on the outer circumferential side. Nine teeth 44 projected to the center of the cylinder from the core yoke 43 are disposed at equal intervals in a circumferential direction. 101. More specifically, the teeth 44 are disposed with a gap on the same circumference.

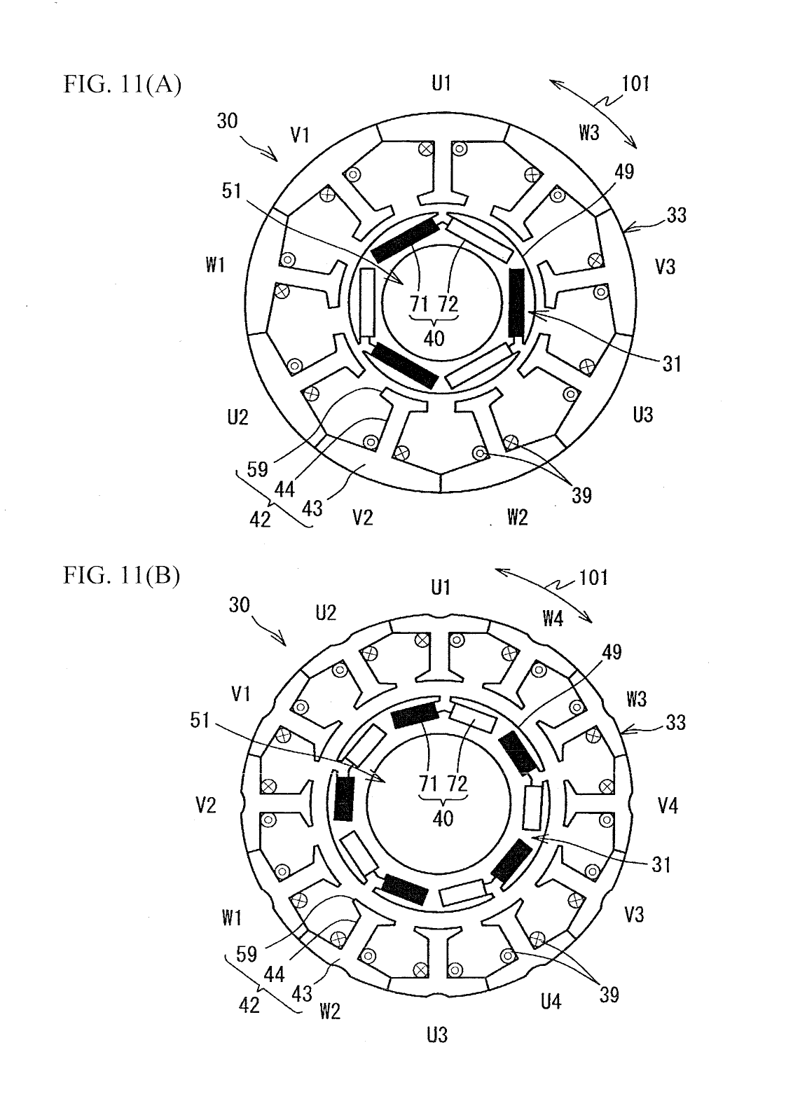

The insulator 45 illustrated in FIGS. 1 to 4 are constituted by a member disposed at one side of the stator core 42 in the axial direction. 102 and a member disposed at the other side. The two members each are integrally molded. The two members are connected in such a manner as to sandwich each of the nine teeth 44. Thus, the insulator 45 is fitted onto each of the teeth 44. In FIGS. 6 and 11, the illustration of the insulator 45 is omitted.

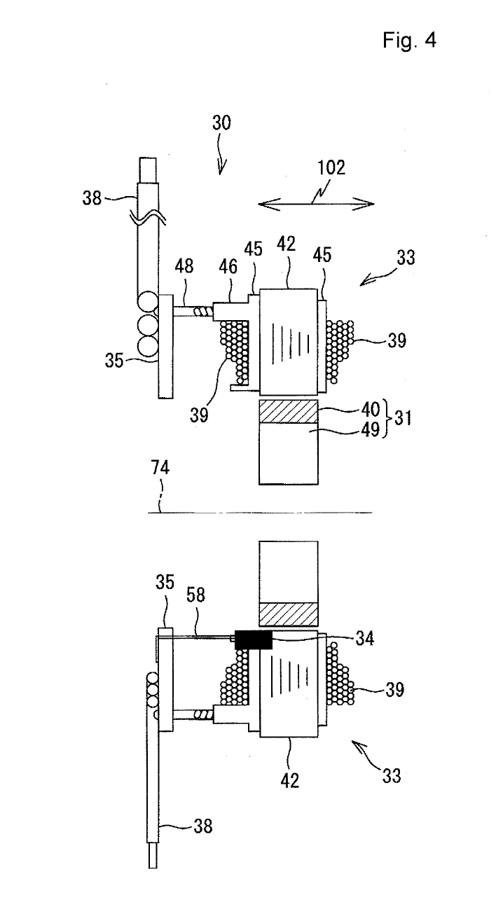

As illustrated in FIGS. 2 to 4, a projection portion 45 projected in the axial direction 102 is provided in the member disposed at one side of the stator core 42 in the axial direction 102 of the insulator 45. As illustrated in FIGS. 3 and 4, the projection portions 46 are disposed at equal intervals along the circumferential direction 101. A hole 47 is formed in some of the projection portions 46. The holes 47 are disposed at equal intervals along the circumferential direction 101. In this embodiment, although six holes 47 are provided, the number of the holes 47 is not limited to six pieces. The end side of a support 48 (refer to FIG. 4) is attached to the hole 47. The printed circuit board 35 described later is attached to the other end side of the support 48.

As illustrated in FIGS. 1 to 4, the coil 39 is wound around each of the teeth 44 through the insulator 45. Herein, as illustrated in FIG. 6(F), the projection tip portion of each of the teeth 44 forms a wide portion 59 whose length in the circumferential direction 101 is longer than that of other portioned of each of the teeth 44. Thus, the wound coil 39 can be prevented from separating from the tip portion side of each of the teeth 44. As illustrated in FIG. 1, the coil 39 is electrically connected to the controller 37 to generate a magnetic field based on the voltage supplied from the controller 37.

As illustrated in FIG. 6(B), the nine coils 39 each wound around each of the teeth 44 of the stator core 42 are classified into 3 phase of a U phase, a V phase, and a W phase according to the phase of the voltage applied from the controller 37. In FIG. 6(B), the three coils 39 are classified into the U phase, and indicated as U1, U2, and U3. The three coils 39 are classified into the V phase, and indicated as V1, V2, and V3. The three coils 39 are classified into the W phase, and indicated as W1, W2, and W3.

In the stator 33, the coils 39 of each phase are disposed from the position at 12:00 in FIG. 6(A) in a counterclockwise direction in order of U1, U2, U3, V1, V2, V3, W1, W2, and W3.

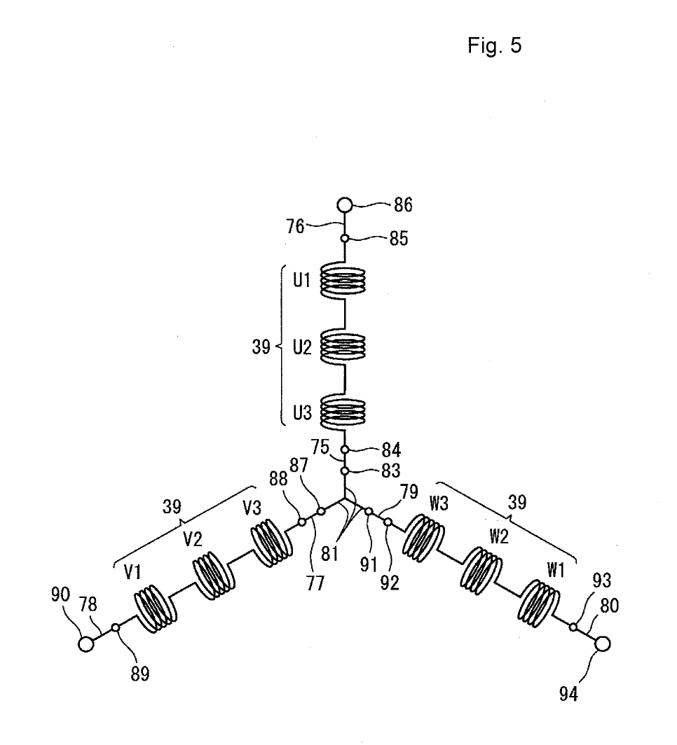

As illustrated in FIG. 5, among the nine coils 39, U1, U2, and U3 are connected in series, V1, V2, and V3 are connected in series, and W1, W2, and. W3 are connected in series. More specifically, the coils 39 are continuously wound around a group of the three teeth 44 adjacent in the circumferential direction into a group. Thus, the nine coils 39 form a coil group of U1, U2, and U3 to which a voltage of the U phase is applied, a coil group of V1, V2 and V3 to which a voltage of the V phase is applied, and a coil group of W1, W2, and W3 to which a voltage of the W phase is applied. More specifically, the nine coils 39 form the three coil groups. One end of each of the three coil groups is connected at the neutral point. More specifically, the three coil groups are star-connected.

### [Rotor 31]

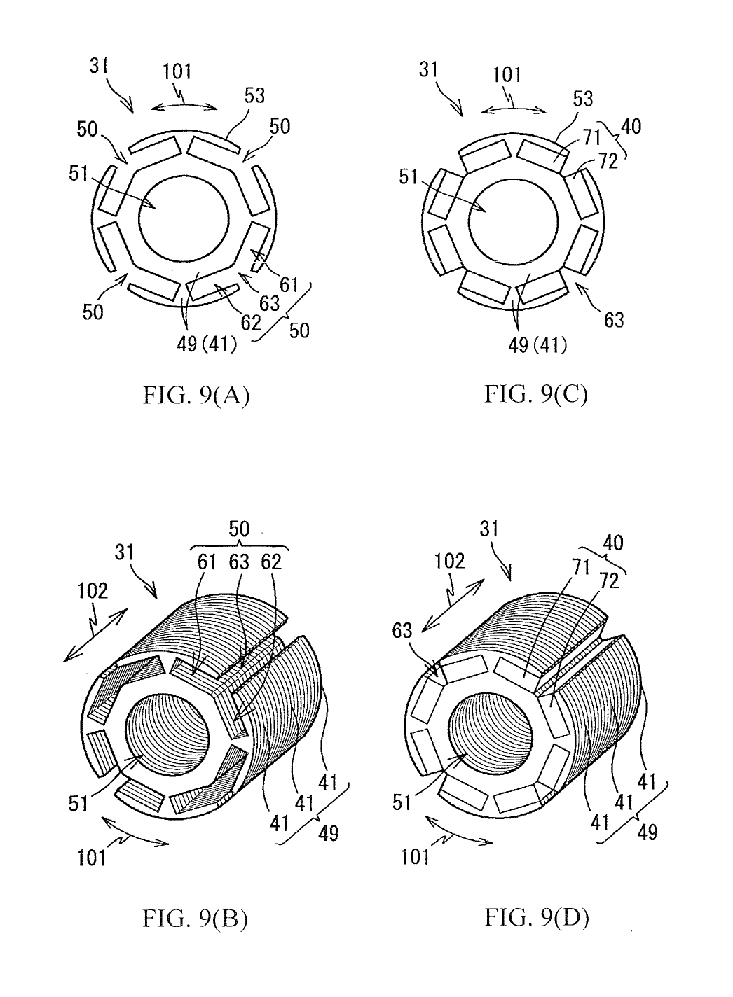

As illustrated in FIGS. 1 to 4 and FIG. 6(B), the rotor 31 is provided inside the stator core 42. In FIGS. 2 to 4, the rotor 31 is schematically illustrated. The rotor 31 contains the rotor yoke 49 and eight magnets 40. As illustrated in FIG. 9, the rotor yoke 49 presents an approximately cylindrical shape. As illustrated in FIG. 9(B), in the rotor yoke 49, a plurality of disk -shaped steel plates 41 are laminated in the axial direction 102, and are combined to each other by crimping. As illustrated in FIG. 6(B), the outer circumferential surface 53 of the rotor yoke 49 faces the teeth 44 provided in the stator core 42 with a gap.

As illustrated in FIGS. 9(A) and 9(B), through-holes 50 described later are formed at positions separated in the circumferential direction 101 in each steel plate 41. Moreover, a through-hole 51 is formed also in the center of each steel plate 41. The shaft 32 extending in the axial direction 102 is press-fitted into the through-hole 51. As illustrated in FIG. 1, the shaft 32 is rotatably supported by the housing 36 through a bearing 52. Thus, the rotor 31 can rotate around an axis line 74 (refer to FIG. 4) passing through the center of the shaft 32, i.e., the center of the same circumference on which the teeth 44 are disposed.

As illustrated in FIGS. 9(A) and 9(B), the four through-holes 50 are provided on the outer circumferential side of the rotor yoke 49 in such a manner as to be equally separated in the circumferential direction 101. The through-hole 50 contains a first insertion region 61 and a second insertion regions 62 of an approximately rectangular parallelepiped shape and a communication region 63.

As illustrated in FIG. 9(A), in all the steel plates 41, the first insertion region 61 is disposed on the counterclockwise side of the second insertion region 62. In other words, the second insertion region 62 is disposed on the clockwise side of the first insertion region 61. The first insertion region 61 and the second insertion region 62 are disposed with an interval in the circumferential direction 101.

The communication region 63 is provided between the first insertion region 61 and the second insertion region 62 in the circumferential direction 101. The communication region 63 is continuous to the first insertion region 61 at one end in the circumferential direction 101 and is continuous to the second insertion region 62 at the other end in the circumferential direction 101. More specifically, the communication region 63 communicates end portions facing each other of the first insertion region 61 and the second insertion region 62. As described above, the first insertion region 61 is located at one side in the circumferential direction 101 of the communication region 63 in all the steel plates 41. The second insertion region 62 is located at the other side in the circumferential direction 101 of the communication region 63.

Moreover, the communication region 63 opens to the outer circumferential surface 53 of the rotor yoke 49. More specifically, the communication region 63 opens to the edge facing the teeth 44.

The eight magnets 40 earn are configured to have a shape which allows the insertion into the through-hole 50. The magnet 40 according to this embodiment has a rectangular parallelepiped shape. The magnet 40 is a permanent magnet. The eight magnets 40 are classified into first magnets 71 and second magnets 72. The first magnet 71 is inserted into the first insertion region 61 in the state where one of the N pole or the S pole is on the outer circumferential side. The second magnet 72 is inserted into the second insertion region 62 in the state where the other one of the N pole or the S pole is on the outer circumferential side. In this embodiment, four first magnets 71 and four second magnets 72 are provided. The first magnets 71 and the second magnets 72 each are fixed to the wall which defines the first insertion region 61 and the second insertion region 62 with an adhesive or the like.

The four first magnets 71 each are inserted into the first insertion region 61 each of the four through-holes 50. Moreover, the four second magnets 72 each are inserted into the second insertion region 61 of each of the four through-holes 50. As described above, the outer circumferential surface 53 of the rotor yoke 49 faces the teeth 44 with a gap. As described above, the rotor 31 has eight poles by the eight magnets 40 whose N pole and S pole are alternately arranged in the circumferential direction 101 and which are disposed facing the teeth 44 with a gap.

### [Hall Element 34]

As illustrated in FIGS. 2 and 3, the brushless motor 30 has three hall elements 34 (an example of the magnetic sensor of the present invention). The hall element 34 is a radial component having a power supply, a ground, and three leads 58 (refer to FIG. 4) for signals. As illustrated in FIG. 4, the hall element 34 is mounted on the printed circuit board 35 described later.

As illustrated in FIGS. 2 and 3, each of the three hall elements 34 is disposed in the gap formed between the two adjacent wide portions 59 of the teeth 44. The length in the circumferential direction. 101 of the pap between the adjacent wide portions 59 is almost equal to the length in the circumferential direction 101 of the hall element 34. Herein, the fact that the two lengths described above are almost equal to each other means that an error caused by the dimensional tolerance of the hall elements 34, and the arrangement tolerance of the teeth 44 is permitted. As described above, due to the fact that the two lengths are almost equal to each other, the hall element 34 is positioned in the circumferential direction 101 by abutting on at least one of the teeth 44 on both sides in the circumferential direction 101.

Moreover, each of the three hall elements 34 is disposed in each of different three gaps among nine gaps formed between the adjacent two teeth 44. In this embodiment, the three hall elements 34 are disposed at equal intervals in the circumferential direction 101. More specifically, in this embodiment, two gaps where the hall element 34 is not disposed are present between each of the three hall elements 34. However, the three hall elements 34 may not be disposed at equal intervals in the circumferential direction 101. For example, each of the three hall elements 34 may be disposed in the three gaps adjacent to each other. As described above, the hall elements 34 each may be disposed in at least three gaps among the adjacent teeth 44.

The positions in the axial direction 102 of the three hall elements 34 may be any position insofar as the magnet 40 provided in the rotor 31 can face the hail element 34. Moreover, the three hall elements 34 are disposed on the same circumference around the through-hole 51. The positions in the radial direction of the three hall elements 34 are positions not contacting the magnet 40 or the rotor 31. Moreover, the positions in the radial direction of the three hall elements 34 are preferably closer to the magnet 40 in order to detect the rotation angle of the rotating rotor 31.

### [Printed Circuit Board 35]

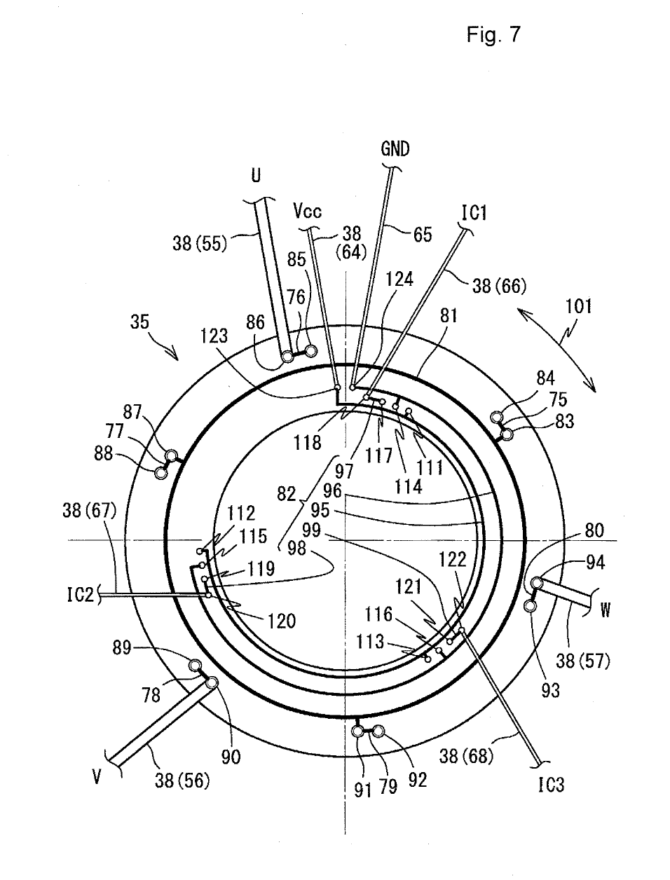

As illustrated in FIGS. 1 and 4, the printed circuit board 35 is disposed apart from the stator core 42 on one end side in the axial direction. 102 of the stator core 42. The printed circuit board 35 has an annular as viewed in plan view in FIG. 7 (i.e., as viewed from the axial direction 102). As illustrated in FIG. 4, the outer diameter of the annular ring is almost the same as the outer diameter of the stator core 42. The internal diameter of the annular ring is almost the same as the internal diameter of the stator core 42. A substrate fixation hole (non-illustrated) is provided at a position corresponding to the support 48 of the printed circuit board 35. The printed circuit board 35 is supported by the insulator 45 by tightening a screw (non-illustrated) inserted into the substrate fixation hole to the support 43. The shape of the printed circuit board 35 is not limited to the annular shape and may be any shape insofar as an opening into which the shaft 32 can be inserted is formed.

As illustrated in FIG. 4, the three hail elements 34 are mounted on the printed circuit board 35. As illustrated in FIG. 7, the printed circuit board 35 is provided with through holes 111 to 117, 119, and 121 into which the three leads 58 (a power supply lead, a ground lead, and a signal lead) extended from each of the three hall elements 34 (hereinafter also referred to as 101, 102, and 103) are inserted. Then, the three hall elements 34 are mounted on the printed circuit board 35 by soldering the nine leads 58 in total inserted into the through holes 111 to 117, 119, and 121.

The three leads 58 extended from the 101 are inserted into the through holes 111, 114, and 117 illustrated in FIG. 7. The three leads 58 extended from the IC2 are inserted into the through holes 112, 115, and 119 illustrated in FIG. 7. The thee leads 58 extended from IC3 are inserted into the through holes 113, 116, and 121 illustrated in FIG. 7,

As illustrated in FIG. 7, the printed circuit board 35 has a first circuit pattern 81, a second circuit pattern 82, and a plurality of through holes. The first circuit pattern 81 is connected to through holes 83, 87, and 91.

As illustrated in FIG. 5 and FIG. 7, the through hole 83 is connected to a through hole 84 through a circuit pattern 75. The through hole 84 is connected to the 113 which is one end of the three coils 39 classified into the U phase. The U1 which is the other end of the three coils 39 classified into the U phase is connected to a through hole 85. The through hole 85 is connected to the through hole 86 through a circuit pattern 75. The through hole 86 is connected to an electric wire 55 for supplying the U phase voltage among the harnesses 38. Thus, the U phase voltage can be supplied to the coil 39 from the controller 37.

As illustrated in FIG. 5 and FIG. 7, the through hole 87 is connected to a through hole 88 through a circuit pattern 77. The through hole 88 is connected to the V3 which is one end of the three coils 39 classified into the V phase. The V1 which is the other end of the three coils 39 classified into the V phase is connected to a through hole 89. The through hole 89 is connected to a through hole 90 through a circuit pattern. 78. The through hole 90 is connected to an electric wire 56 for supplying the V phase voltage among the harnesses 38. Thus, the V phase voltage can be supplied to the coil 39 from the controller 37.

As illustrated in FIG. 5 and FIG. 7, the through hole 91 is connected to a through hole 92 through a circuit pattern 79. The through hole 92 is connected to the W3 which is one end of the three coils 39 classified into the W phase. The W1 which is the other end of the three coils 39 classified into the W phase is connected to a through hole 93. The through hole 93 is connected to a through hole 94 through a circuit pattern 80. The through hole 94 is connected to an electric wire 57 for supplying the W phase voltage among the harnesses 38. Thus, the W phase voltage can he supplied to the coil 39 from the controller 37.

As described above, the coil group U1, U2, and U3 constituting the U phase, the coil group V1, V2, and V3 constituting the V phase, and the coil group W1, W2, and W3 constituting the W phase are connected with the neutral points through the first circuit pattern 81.

The second circuit pattern 82 contains a power supply circuit pattern 95, a ground circuit pattern 96, a first signal circuit pattern 97, a second signal circuit pattern 98, and a third signal circuit pattern. 99.

The power supply circuit pattern 95 is connected to the through holes 111, 112, and 113 to which power supply leads of the IC1, the 102, and the 103 are soldered. The power supply circuit pattern 95 is connected to the through hole 123 connected to an electric wire 64 for supplying a voltage to the hall element 34.

The ground circuit pattern. 96 is connected to the through holes 114, 115, and 116 to which ground leads of the I01, the 102, and the 103 are soldered. The ground circuit pattern 96 is connected to the through hole 124 connected to an electric wire 65 for grounding the hall element 34,

One end of the first signal circuit pattern 97 is connected to the through hole 117 to which a signal lead of the 101 is soldered. The other end of the first signal circuit Pattern 97 is connected to the through hole 118 connected to an electric wire 66 for signals of the IC1. One end of the second signal circuit pattern 98 is connected to the through hole 119 to which a signal lead of the 102 is soldered. The other end of the second signal circuit pattern 98 is connected to the through hole 120 connected to an electric wire 67 for signals of the 102. One end of the third signal circuit pattern 99 is connected to the through hole 121 to which a lead for signals of the 103 is soldered. The other end of the third signal circuit pattern 99 is connected to the through hole 122 connected to an electric wire 68 for signals of the 103. As described above, the second circuit pattern 81 is connected to each of the three hail elements 34.

[Phase Voltage of Brushless Motor 30 According to this Embodiment]

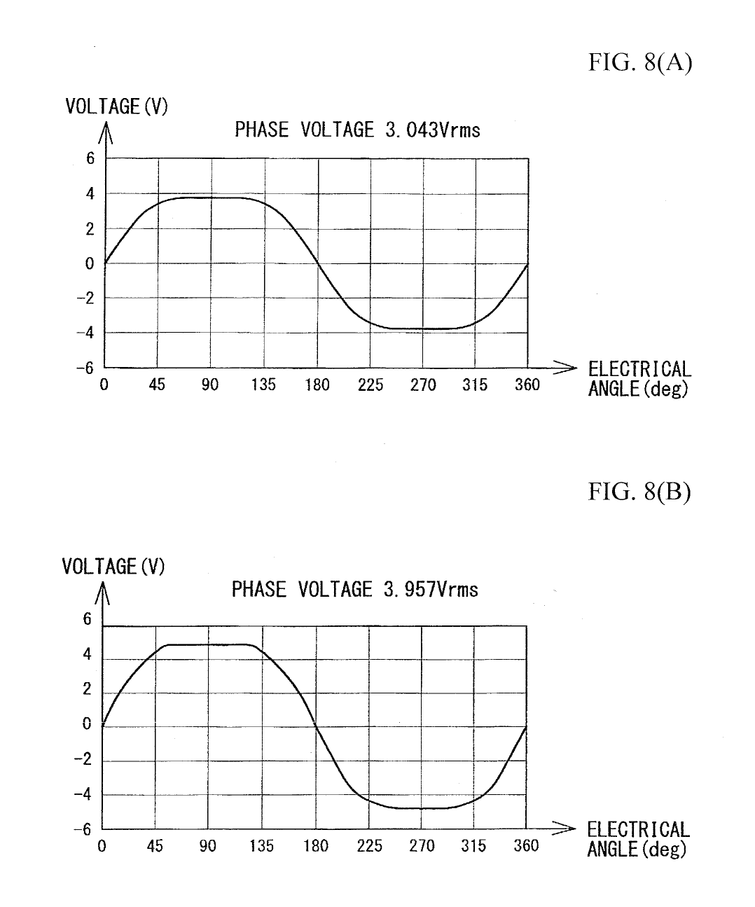

FIG. 8(B) illustrates the relationship of the electric angle and the has voltage when operating the brushless motor 30 of this embodiment illustrated in FIG. 6(B). FIG. 8(A) illustrates the relationship of the electric angle and the phase voltage when operating the brushless motor 30 (refer to FIG. 6(A)) illustrated in FIG. 6(A). The brushless motor 30 illustrated in. FIG. 6(A) has the same configuration as that of the brushless motor 30 according to this embodiment, except that the communication region 63 is not provided.

When FIG. 8(A) and 8(B) are compared, the phase voltage in FIG. 8(B) is about 130% larger than the phase, voltage in FIG. 8(A). This is because the brushless motor 30 according to this embodiment is provided with the communication region 63, and therefore leakage flux is kept lower than the brushless motor 30 according to FIG. 6(A).

When FIGS. 8(A) and 8(B) is compared, the positive/negative characteristics of the voltage in FIG. 8(A) are symmetrical. On the other hand, the positive/negative characteristics of the voltage in FIG. 8(A) are a little asymmetrical near the maximum value of the voltage size. The reason why the characteristics in FIG. 8(A) are symmetrical lies in that the brushless motor 30 is constituted to be equilibrium. The reason why the characteristics in FIG. 8(B) are asymmetrical lies in that the brushless motor 30 is constituted to be disequilibrium because the brushless motor 30 has the communication region 63. However, as is clear from FIG. 8(B), the asymmetry of the characteristics is very slight. This is because the brushless motors 30 according to this embodiment has the features of the present invention; the nine teeth 44 are provided, the magnet has eight poles, a so-called 8 pole 9 slot, configuration, the coil 39 is wound and connected as illustrated in FIG. 5, and the like.

[Operation Effects of this Embodiment]

According to this embodiment, the all elements 34 disposed in the gaps between adjacent teeth 44 face the magnets 40 provided In the rotor 31. Therefore, the hall element 34 output voltages corresponding to the magnetic pole of the magnets 40 provided in the rotor 31. Therefore, it is not necessary to provide a magnet for the hall elements 34. Thus, the cost-up of the brushless motor 30 can be suppressed. Moreover, since the hall elements 34 are disposed in the gaps between the adjacent teeth 44, it is not necessary to provide a space for disposing the hall elements 34 in the brushless motor 30. Therefore, an increase in size of the brushless motor 30 can be suppressed.

Moreover, according to this embodiment, the first circuit pattern 81 connecting each coil 39 and the second circuit pattern 82 connected to the hall elements 34 are formed on one printed circuit board 35. Therefore, it is not necessary to dispose two or more of the printed circuit boards 35. Thus, the cost up of the brushless motor 30 by providing a plurality of printed circuit boards 35 can be suppressed. Moreover, since the space for arrangement the printed circuit board 35 can be made small, an increase in size of the brushless motor 30 can be suppressed.

Moreover, according to this embodiment, the hail elements 34 are positioned in the circumferential direction 101. Therefore, the detection accuracy of the rotation Position of the rotor 31 by the hall element 34 can be raised.

Moreover, according to this embodiment, since the three coil groups are connected through the first circuit pattern 81 at the neutral point, a circulation current, does not flow. Furthermore, the coils 39 form the three coil groups constituting the U phase, the V phase, and the W phase in the continuously adjacent three teeth 44 forming one group. Therefore, even when the brushless motor 39 is configured to be disequilibrium, the asymmetry of the positive/negative waveforms of the phase voltage to the electric angle can be made small.

Moreover, according to this embodiment, the stator core 42 has the nine teeth 44 and the rotor 31 has eight poles. More specifically, the brushless motor 30 has a 8 pole 9 slot configuration. As compared with a brushless motor of a different number of roles and a different number of slots (for example, 6-pole 9-slot), the brushless motor 30 of 8 role 9 slot is a motor with low cogging torque and the phase voltage can be generated with high efficiency. When the number of slots is larger than the nine slots, the gaps between the adjacent teeth 44 become small, which makes it difficult to form a space for disposing the hall elements 44 in the gaps. On the other hand, in the brushless motor 30 of 9 slots, it is easy to form a space for disposing the hall elements 34 in the gaps between the adjacent teeth 44.

Moreover, according to this embodiment, the brushless motor 30 is configured to be disequilibrium due to that fact that the communication region 63 is provided in the rotor 31. However, according to this embodiment system, as described above, the asymmetry of the positive/negative waveforms of the phase voltage can be made very small.

Moreover according to this embodiment, the communication region 63 is provided between the first magnet 71 and the second magnet 72. Therefore, the cross-sectional area of the rotor yoke 49 between the first magnet 71 and the second magnet 72 becomes small. Thus, the magnetic resistance of the rotor yoke 49 becomes high between the first magnet 71 and the second magnet 72. As a result, so-called leakage flux in which a part of the magnetic flux caused by either one of the first magnet 71 or the second magnet 72 is not directed to the coil 39 but is directed to the other one of the first magnet 71 or the second magnet 72 can be reduced. Thus a high phase voltage can be obtained, and therefore the rotor 31 can be rotated with high efficiency.

Moreover, according to this embodiment, in all the steel plates 41, the positions of the communication region. 53 in the circumferential direction 101 are the same. Therefore, the leakage flux between the first magnet 71 and between second magnet 72 disposed facing both sides in the circumferential direction 101 of the communication region 63 can be considerably reduced,

### [Modification]

In the above-described embodiment, as illustrated in FIG. 9, in all the steel plates 41 constituting the rotor yoke 49, the first insertion region 61 is disposed on the counterclockwise side of the second insertion region 62 and the second insertion region 62 is disposed on the clockwise, side of the first insertion region 61. However, the arrangement of the first insertion region 61 and the second insertion region 62 is not limited thereto.

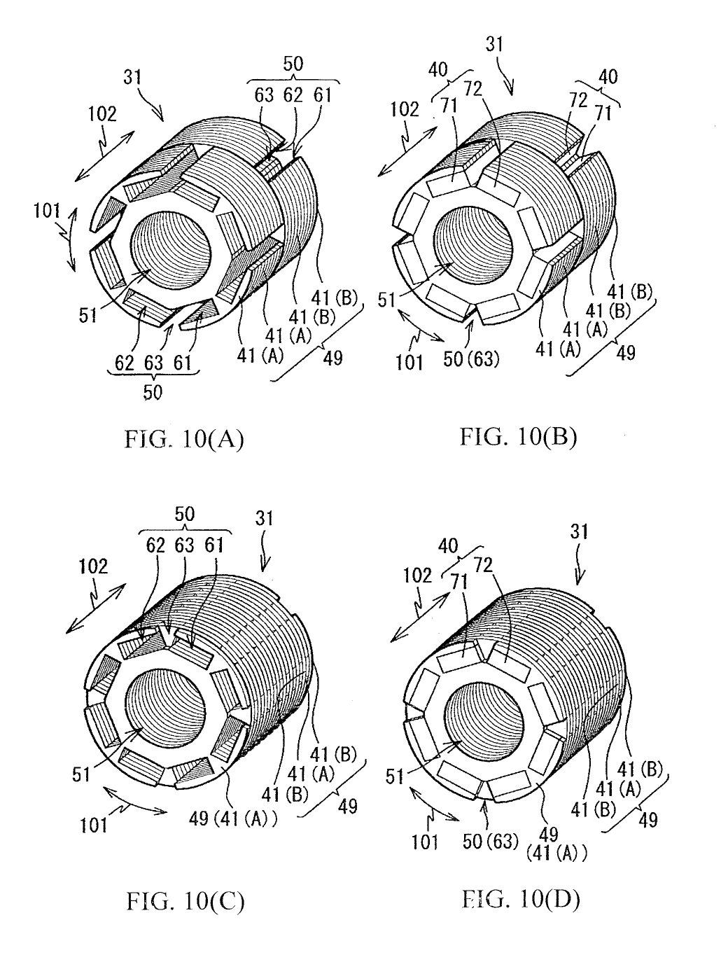

For example, as illustrated in FIG. 10, each steel plate 41 may be classified into a first steel plate 41A and a second steel plate 41B. Then, in the first steel plate 41A, the first insertion region 61 may he disposed on the counterclockwise side of the second insertion region 62 and the second insertion region 62 may be disposed on the clockwise side of the first insertion region 61. In the second steel plate 415, the first insertion region 61 may be disposed on the clockwise of the second insertion region 62 and the second insertion region. 62 may be disposed on the counterclockwise side of the first insertion region 61.

More specifically, in the first steel plate 41A, the first insertion region 61 may be disposed on one side in the circumferential direction 101 of the communication region 63 and the second insertion region 62 may be disposed on the other side in the circumferential direction 101 of the communication region 63. In the second steel plate 42B, the first insertion region 61 may be disposed on the other side in the circumferential direction 101 of the communication region 63 and the second insertion region 62 may be disposed on one side in the circumferential direction 101 of the communication region 63.

The rotor yoke 49 in this case may be one in which the first, steel plate group in which the first steel plates 41A are laminated and the second steel plate group in which the second steel plates 41B are laminated are laminated. For example, as illustrated in FIGS. 10(A) and 10(E), the half of one side in the axial direction 102 may be the first steel plate group and the half of the other side in the axial direction 102 of the rotor yoke 49 may be the second steel plate group.

According to he configuration of FIGS. 10(A) and 10(B), the positions of the communication regions 63 in the circumferential direction 101 are different from each other between the first steel plate group and the second steel plate group. Therefore, portions where the intensity decreases due to the presence of the communication regions 63 of the rotor yokes 49 can be dispersed.

In the rotor yoke 49 in which each steel plate 41 is classified into the first, steel plate 41A and the second steel plate 41B, the first steel plate 41A and the second steel plate 41E may he alternately laminated as illustrated in FIGS. 10(C) and 10(D).

According to FIGS. 10(C) and 10(D), in the steel plates 41 adjacent to each other in the axial direction 102, the positions of the communication regions 63 in the circumferential direction 101 are different from each other. Therefore, portions where the intensity reduces due to the presence of the communication regions 63 of the rotor yokes 49 can be dispersed.

In the above-described embodiment, although the nine teeth 44 are provided, the number of the teeth 44 may not be nine insofar as the number of the teeth 44 is three or more.

In the above-described embodiment, although the insulator 45 is constituted by the two members, the number of the members constituting the insulator 45 may be not two. For example, the insulator 45 may be constituted by two members in each of the teeth 44. More specifically, when the nine teeth 44 are provided, the insulator 45 may be constituted by 18 members in total.

As in the above-described embodiment, although it is desirable that the bushless motor 30 is the 8 pole 9 slot type, the number of poles and the number of slots are not limited thereto. For example, the brushless motor 30 may be a 6-pole 9-slot type as illustrated in FIG. 11(A) or may be a 10-pole 12-slot type as illustrated in FIG. 11(B).

In the above-described embodiment, the rotor 31 with eight poles is configured by the eight magnets 40 provided in each pole but the configuration of the rotor 31 is not limited to such a configuration. For example, the rotor 31 with eight poles may be configured by combining two arc-shaped magnets 40 in which four magnetic poles are formed by alternately providing the N pole and the S pole in the circumferential direction 101.

In the above-described embodiment, the three hall elements 34 are provided but four or more of the hall elements 34 may be provided.

Although the stator 33 according to the above-described embodiment has one stator core 42 having the nine teeth 44, the stator core 42 may be divided into a plurality of pieces.

The brushless motor 30 according to the above-described embodiment may be a so-called an inner rotor type in which the rotor 31 is formed inside the stator core 42 but may be an outer rotor type in which the rotor 31 was provided outside the stator core 42. In this case, the communication regions 63 of the through-holes 50 open to the inner circumference side of the rotor yoke 49.

1. A brushless motor, comprising:
a stator core in which at least three teeth disposed with a gap on the same circumference are projected from a core yoke;
an insulator fitted onto the teeth;
a coil wound around each of the teeth through the insulator;
a rotor which has a multipolar magnet disposed facing the teeth with a cap and which can freely rotate around the axis line passing through the center of the same circumference;
a magnetic sensor disposed in each of at least three gaps among the gaps of the adjacent teeth; and
a printed circuit board which is supported by the insulator at one end side in the axis line direction of the stator core and on which each magnetic sensor is mounted, wherein
the printed circuit board has a first circuit pattern which connects each coil and a second circuit pattern which is connected to the magnetic sensors.

2. The brushless motor according to claim 1, wherein each of the magnetic sensor is positioned in the circumferential direction or the same circumference by abutting on the teeth.

3. The brushless motor according to claim 1, wherein
the number of the teeth of the stator core is nine,
the magnets have eight poles,
the coils form three coil groups constituting a U phase, a V phase, and a W phase, each coil group having three teeth which are continuously adjacent, and
the three coil groups are connected with neutral point through the first circuit pattern.

4. The brushless motor according to Claim, wherein
the multipolar magnet contains a plurality of magnets in each pole,
the rotor has a motor yoke in which a plurality of steel plates are laminated to form a cylindrical shape,
a through-hole into which each magnet is inserted is formed in each steel plate, and
the through-hole has a first insertion region into which a first magnet among the plurality of magnets is inserted, a second insertion region which is disposed with an interval from the first insertion region in the circumferential direction on the same circumference and into which a second magnet among the plurality of magnets is inserted, and a communication region which communicates end portions facing each other of the first insertion region and the second insertion region and opens to a edge facing the teeth.

5. The brushless motor according to claim 4, wherein the first insertion region is located on one side in the circumferential direction of the communication region and the second insertion region is located on the other side in the circumferential direction of the communication region.

6. The brushless motor according to claim 4, wherein
each steel plate is either a first steel plate in which the first insertion region is located on one side in the circumferential direction of the communication region and the second insertion region is located on the other side in the circumferential direction of the communication region or a second steel plate in which the first insertion region is located the other side in the circumferential direction of the communication region and the second insertion region is located on one side in the circumferential direction of the communication region, and
the rotor yoke is obtained by laminating a first steel plate group in which the first steel plates are laminated and a second steel plate group in which the second steel plates are laminated.

7. The brushless motor according to claim 4, wherein
each steel plate is either a first steel plate in which the first insertion region is located on one side in the circumferential direction of the communication region and the second insertion region is located on the other side in the circumferential direction of the communication region or second steel plate in which the first insertion region is located the other side in the circumferential direction of the communication region and the second insertion region is located on one side in the circumferential direction of the communication region, and
the rotor yoke is obtained by alternately laminating the first steel plate and the second steel plate.
